(19) United States
(12) Patent Application Publication
(10) Pub. No.: US 2026/0286615 A1
(43) Pub. Date: Sep. 24, 2026

(54) PACKAGING WEB MATERIAL, PACKAGING POUCH AND PROCESS FOR FORMING A PACKAGING POUCH

(71) Applicant: Mondi AG, Wien (AT)

(72) Inventors: Maciej KOWALSKI, Warschau (PL); Trevor PLANT, Halle (DE); Nadia EL-KARZAZI, Bielefeld (DE)

(73) Assignee: Mondi AG, Wien (AT)

(21) Appl. No.: 19/475,781

(22) PCT Filed: Apr. 10, 2024
(86) PCT No.: PCT/EP2024/059713

§ 371 Date: Oct. 16, 2025

(30) Foreign Application Priority Data
Apr. 17, 2023 (DE) 10 2023 109 626.5
Apr. 21, 2023 (DE) 10 2023 110 245.1

(51) Int. Cl. D21H 19/84; B31B 70/26; B31B 155/00; B65D 30/08; D21H 11/04; D21H 19/36; D21H 19/68; D21H 19/82; D21H 21/16; D21H 27/10

(52) U.S. Cl. CPC D21H 19/84; B31B 70/26; B65D 31/02; D21H 11/04; D21H 19/36; D21H 19/68; D21H 19/82; D21H 21/16; D21H 27/10; B31B 2155/00

(57) ABSTRACT

A packaging web material composed of a paper ply has a barrier coating on a first side and a print on an opposite second side. The paper ply has a coated surface formed from a pigment coating on the first side. The paper ply has, on the second side, an uncoated surface or a coated surface formed from a pigment-free coating on which the print has been applied.

The invention relates to a packaging web material composed of a paper ply, which has a barrier coating on a first side and printing on an opposite, second side, and wherein the paper ply has a coated surface formed by a pigment coating on the first side. The packaging web material can also be configured as a sheet material. In this regard, this is a material that has been punched or cut out of a web.

Packaging web materials of the type described initially are fundamentally known from the state of the art and serve to package packaged products individually or in multiple numbers, wherein within the scope of the invention, the packaged products are mainly products from the foods sector. In this regard, it is decisive that the packaging web material has barrier properties, so as to limit the entry of oxygen or the exit of water vapor, for example. Due to the entry of oxygen, the shelf life of the packaged product can be reduced, for example, while the exit of water vapor results in drying out of the packaged product. The packaging materials usually used for this purpose usually consist of a plastic film that is either configured in a single layer, and the polymer used already has corresponding barrier properties. Alternatively, it is also possible, however, to provide a multi-layer plastic film, wherein then the polymers of the individual layers can be selected with regard to the barrier properties.

Specifically with regard to the sustainability of such packaging web materials, nowadays it is often desired to configure the packaging web materials on the basis of paper, so that now a paper ply represents the basis for the types of packaging formed from them. Depending on the packaged product to be packaged, it is necessary, in this regard, to additionally coat the paper ply with a barrier coating, wherein this barrier coating can additionally form a fat barrier. In contrast to plastic films, paper has only a low resistance to fat, so that for example in the case of foods that contain fat, for example chocolate bars, a corresponding barrier coating is required so as to prevent fat from penetrating the packaging. Such fat penetration is disadvantageous, in this regard, not only from optical aspects but also from hygiene aspects.

Often the barrier coating is applied to an uncoated side of the paper ply, while an opposite side, having a coated surface, is used to apply printing. A coated surface is formed by application of a coating, in particular a pigment coating. In this way, the surface is sealed and made smooth, so that the printing has a particularly high-quality effect.

WO 2022/079178 A1 has recognized, in this regard, that it can be particularly practical, also with regard to the barrier coating, if this coating is applied to a coated surface, because in this way the barrier coating does not penetrate particularly deeply into the paper ply, and thereby a continuous, sealed barrier coating can be formed particularly effectively.

Although the solutions known until now have fundamentally proven themselves, it is to reduce the proportion of foreign substances, in particular of polymers, specifically with regard to particularly good recyclability.

The present invention is therefore based on the task of indicating a packaging web material that can be recycled particularly well, which furthermore distinguishes itself from the previously known packaging web materials, also in an optical aspect, by a particular design.

The object of and solution for this task is a packaging web material in accordance with claim 1.

Accordingly, it is provided, according to the invention, that the paper ply has either a non-coated surface or a coated surface formed from a pigment-free coating, to which the printing is applied, on the second side. Thereby the second side is untreated, at least to the greatest possible extent, but preferably completely, wherein a certain solidification of the paper fibers with one another can be brought about merely by the pigment-free coating. In contrast to the first side, however, no application of a pigment coating, and therefore also no smoothing of the surface takes place. Accordingly, the proportion of foreign substances in the packaging web material can be kept low by doing without a coating or a pigment-free coating, respectively.

By applying the printing to the surface of the second side of the paper ply, the printing ink therefore penetrates relatively deeply into the paper ply. As a result, a rougher printed image, less contoured in comparison, is formed in comparison with a coated surface, which image is, however, still sufficiently clear and visible, so that, in particular, even application of printed information is still possible. By means of the rougher printed image as well as the haptics and the appearance of the surface, the consumer is already provided with the information that the packaging web material being used is particularly sustainable and easy to recycle.

Accordingly, the invention not only makes use of the advantageous combination that the barrier coating can be arranged on the paper ply in a continuous and sealed manner, by means of the pigment coating of the first side, while on the other hand, the proportion of foreign substances on the paper ply is reduced, but also that the consumer can directly perceive the sustainability of the packaging web material based on the composition of the surface of the second side.

According to a preferred embodiment of the invention, the barrier coating has an application weight between 2 and 10 g/m². Particularly preferably, the application weight lies between 3 and 7 g/m². In this regard, a comparatively low application weight can be used, which is sufficient, due to the surface formed by a pigment coating, to achieve a sealed barrier effect.

In this regard, the pigment coating is not restricted to specific types of pigments. Particularly preferably, however, it is a pigment coating that has kaolin, chalk, casein and/or a plastic dispersion as a pigment, exclusively or in part. The pigments of the pigment coating are furthermore bound in a liquid application agent. This application agent can contain water, binder(s), starch, as well as further additives as components. The proportion of the pigments in the pigment coating is preferably between 60 and 80 wt.-%. In the case of the pigment-free coating, only the application agent is used as a coating.

Furthermore, the surface of the first side can also be supplementally calandered so as to additionally increase the smoothness and the density on the surface. In this regard, the paper ply is passed through between two steel rollers, wherein at least one steel roller is additionally heated.

A further development of the invention provides that the barrier coating is a barrier varnish. The barrier varnish is preferably an acrylate-based or a polyolefin-based dispersion. The application of the barrier varnish to the paper ply take place by means of squeegee printing, gravure printing or flexographic printing.

The barrier varnish can furthermore contain polyvinyl alcohol (PVOH) and ethylene vinyl alcohol copolymer (EVOH) as a polymer. EVOH and PVOH are particularly well suited as a barrier for water vapor. In particular, it is provided, in this connection, that the water vapor permeability of the packaging web material, according to DIN 53122-1 at 23° C./50% RH, can be less than 12 g/m²/d. Particularly preferably, it is provided that the water vapor permeability is less than 10 g/m²/d according to DIN 53122-1 at 23° C./50% RH. Furthermore, the barrier varnish can also serve as an oxygen barrier, so as to minimize the introduction of oxygen into the packaging.

Although a certain water vapor permeability is desirable within the scope of the invention, it is provided, above all, that the barrier coating has sufficient fat resistance, so that foods that contain fat can be placed, as a packaged product, into packaging formed from the packaging web material. In this regard, it is preferably provided that the barrier coating has a fat resistance with a target value of less than 10 according to Tappi T559. In particular, a value of less than 8 is preferred. In what is called the Tappi test method, twelve different solutions, in total, having different ratios of oil and solvent, are applied to the packaging web material to be tested, wherein the solutions differ from one another in terms of their aggressiveness with regard to penetration into the barrier coating. After a time period of 15 seconds, the applied drip of the solution is removed, and it is checked whether the solution has penetrated into the material. This is usually evident from a dark spot on the surface. Then the number of solutions that penetrated into the material is noted, wherein the number forms the target value. Accordingly, at a target value of less than 10, only nine or fewer solutions have penetrated into the material.

The paper ply is preferably formed by a kraft paper. A kraft paper is a type of paper having a high strength and consisting almost entirely of cellulose fibers. As a result, it is particularly well suited for the production of packaging.

Within the scope of the invention, a paper ply is particularly advantageously suitable that has a weight per area between 40 and 80 g/m², preferably between 45 and 80 g/m², particularly preferably between 50 and 80 g/m², in particular between 55 and 70 g/m². In this way, good stability and shape retention of the packaging material is guaranteed, on the one hand, while at the same time, the packaging web material can be folded and shaped in a suitable manner. The weight per area of the paper ply is a term that is usually also referred to as grammage and represents a usual value for the definition of types of paper. Proceeding from such a weight per area, the paper ply preferably has a thickness between 30 and 75 μm, particularly preferably between 35 and 75 μm, in particular between 40 and 75 μm. According to a particularly preferred embodiment, the thickness lies between 45 and 65 μm.

A further development of the invention furthermore provides that a sealing layer is arranged, at least in certain sections, on the barrier coating. This sealing layer serves, proceeding from the packaging web material, for forming a packaging, for example a packaging pouch, wherein the sealing seams serve for closing off the packaging pouch. Alternatively, the barrier coating can already have a sufficient sealability, wherein in this case it is possible to do without an additional sealing layer.

However, if an additional sealing layer is provided, this layer is generally applied to the barrier coating over its full area. This makes it possible, on the one hand, to easily manage the process during production. On the other hand, there is relative freedom during sealing, as well, and tolerance of errors during positioning of the sections of the packaging web material to be sealed, since sealing layers always lie on top of one another, in any case, if regions of the first side are laid on top of one another.

However, such an embodiment is not desirable within the scope of the invention, because in this way the proportion of foreign substances, in particular of polymers, on the paper ply is increased, and thereby the recyclability of the packaging web material is reduced. Accordingly, a preferred embodiment of the invention provides that the sealing layer is arranged on the barrier coating in a frame shape or in a frame-shaped pattern. Proceeding from such a frame-shaped pattern, it is then possible to form packaging web sections, by means of cutting off individual sections, which sections merely have a circumferential frame composed of a sealing layer, so that a tubular pouch can be formed by means of folding, for example, which pouch has a sealing layer merely in those regions in which sealing actually needs to be performed, so as to close off the packaging.

All of the other regions are then free of a sealing layer, so that the packaged product can also preferably be arranged in a region of the packaging in which no sealing layer is present. This furthermore has the advantage that in the selection of the polymers for the sealing layer, no attention needs to be paid as to whether these polymers are actually food-safe. Accordingly, it is possible to use comparatively simple sealing layers. In this regard, the sealing layer is particularly preferably composed of a polyolefin, in particular of polyethylene or polypropylene.

Particularly preferably, the sealing layer is a cold-sealing layer. A cold-sealing layer is a sealing layer that is formed from a material that allows sealing at room temperatures solely by means of application of a contact pressure. Accordingly, it is not necessary, in contrast to heat-sealing layers, to heat the sealing jaws required for applying the contact pressure. As a result, such cold-sealing layers are suitable, in particular, for closing off packages for foods or other heat-sensitive packaged products, during the packaging of which the use of heat is not desirable. At the same time, a particularly fast packaging speed can also be made possible, since melting of the sealing layer is not necessary. Usually, the cold-sealing layer consists of a polymer dispersion based on natural rubber latex. Alternatively, it is also possible to form the cold-sealing layer on the basis of polyvinyl acetate or ethylene vinyl acetate copolymers. Such a cold-sealing layer can also be provided, in particular, if, although the barrier coating itself is heat-sealable, such heat-sealing is not desired.

A further development of the invention furthermore provides that a separating layer is arranged on the second side of the paper ply, which side is provided with printing. This separating layer can be a silicone-based separating layer, for example. The separating layer serves to make it possible to roll up the packaging web material after production, without sections of the packaging web, in particular the cold-sealing seams, adhering to further sections of the packaging web. Accordingly, it can be ensured, by way or the separating layer, that the packaging web material can be taken out of the rolled-up packaging web in a simple manner. In this regard, the separating layer can be configured to be relatively thin. In particular, the separating layer has a thickness between 0.5 and 2.5 μm, in particular between 1 and 2 μm. A relatively thin separating layer should also be selected here against the background that the proportion of foreign substances, in particular of polymers, is supposed to be kept low.

In this regard, the invention preferably provides that the paper ply forms more than 90%, preferably more than 95% of the total weight. Accordingly, the barrier coating, the printed layer, the sealing layer and/or the separating layer form less than 10%, particularly preferably less than 5% of the total weight of the packaging web material. The greater the proportion of the paper ply in the total weight, the easier it is to recycle the packaging material together, without additional preparation of the packaging web material or thermal conversion being required. In this regard, the aim should be, in particular, that the paper ply makes up at least 95% of the total weight, if possible.

An object of the invention is furthermore a packaging pouch having a pouch body formed from a packaging web material according to the invention, in accordance with claim 11, wherein the first side of the paper ply, which has the barrier coating, forms the interior. Accordingly, the second side, which has the printing, forms the outside.

Fundamentally, different types of packaging pouches are possible, wherein, however, particularly preferably, the pouch body is configured as a tubular pouch body. According to such an embodiment, the packaging material is then folded onto itself in such a manner that a tube is formed, in which the packaged product is then arranged.

Proceeding from this, the pouch body then has transverse sealing seams at an upper and a lower end, as well as a longitudinal sealing seam that connects the ends, by way of which seam the pouch body is closed off. Such a tubular pouch should particularly preferably be provided when foods are supposed to be packaged as packaged products. In particular, foods that contain fat, for example chocolate bars, granola bars, cookies or the like can be packaged inside the tubular pouch.

The sealing seams are preferably cold-sealing seams, which were formed solely by means of applying a press-down force. The configuration of the cold-sealing layers required for forming the cold-sealing seams has already been explained in detail in connection with the packaging web material.

In the case of a tubular pouch closed off by means of sealing seams, in particular cold-sealing seams, it can be practical if the packaged product is arranged, within the pouch body, in regions of the packaging material that are free of sealing seams, in particular free of cold-sealing seams. As has already been explained above, it is thereby possible to keep the proportion of foreign substances low, while at the same time, no particular requirements are set with regard to life conformity of the materials of the sealing layer.

Furthermore, a method for forming a packaging pouch is an object of the invention, in accordance with claim 15, wherein a packaging web material according to the invention is folded in such a manner that the first side of the paper ply, which has the barrier coating, forms the interior, and the opposite second side of the paper ply forms the outside.

In this regard, sealing layer sections arranged on the barrier coating can be laid on top of one another during folding, in particular exclusively, in such a manner that sealing layer sections that extend in the transverse direction are formed at an upper and a lower end, as well as a sealing layer section that connects the ends in the longitudinal direction is/are formed, and wherein subsequently the pouch body is closed off by means of sealing the sealing seam sections.

Sealing preferably takes place exclusively by means of applying a press-down force onto the sealing seam sections at ambient temperature. Accordingly, the sealing jaws used for sealing are not additionally heated. Such a process is also referred to as cold-sealing. Accordingly, the sealing seam sections are formed from a sealing material that already allows adhesion at low temperatures.

Preferably, before the packaging web material is folded, a packaged product, in particular a food, is arranged on the first side in such a manner that it does not lie against sealing seam sections after folding. The packaged product is preferably a food. Specifically in connection with foods, cold-sealing can also be particularly practical, since no additional temperature introduction into the packaging, and thereby into the packaged product, takes place.

In the following, the invention will be explained in greater detail using an exemplary embodiment. The figures show:

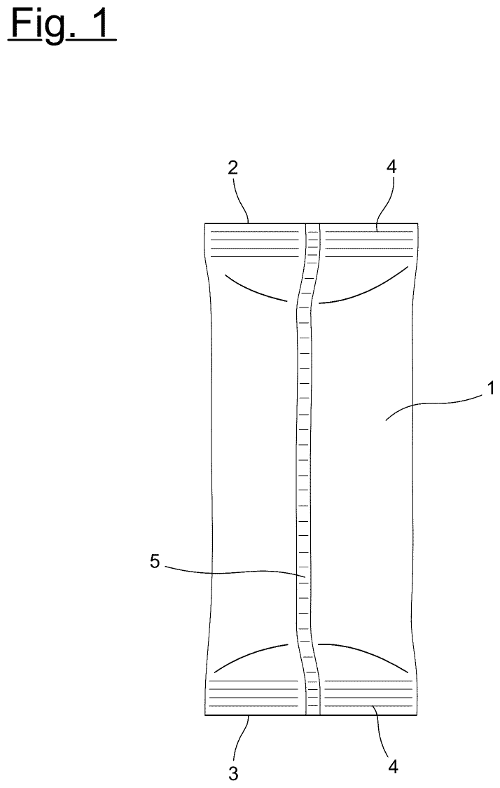

FIG. 1 a packaging pouch according to the invention,

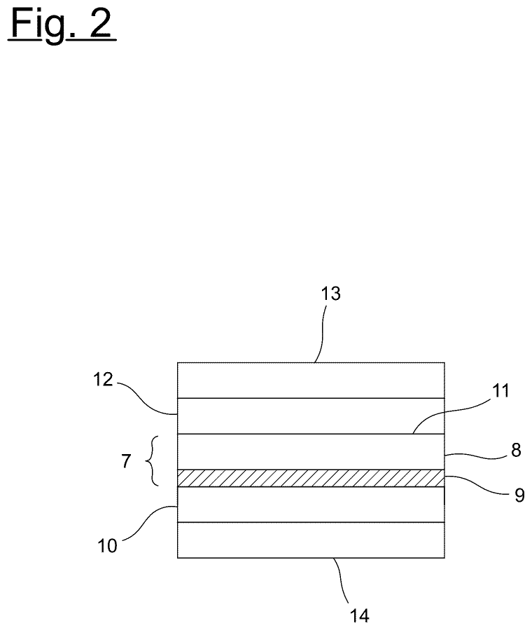

FIG. 2 the packaging web material according to the invention, used for the packaging pouch according to FIG. 1,

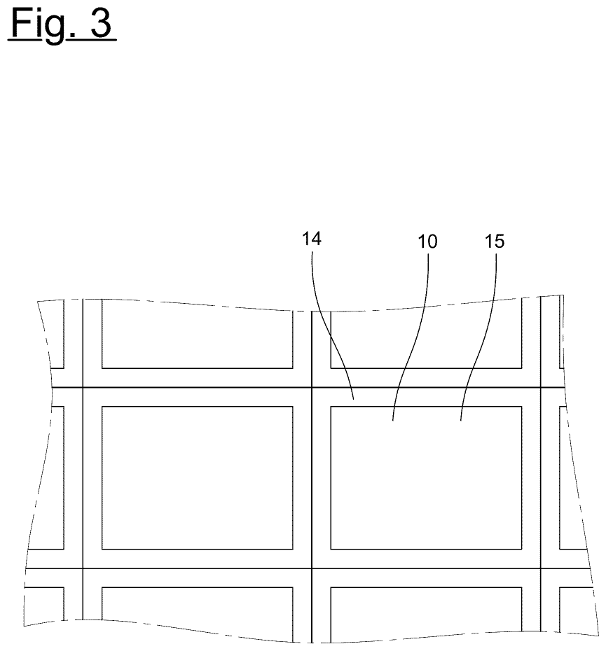

FIG. 3 a top view of the first side of the packaging web material according to FIG. 2,

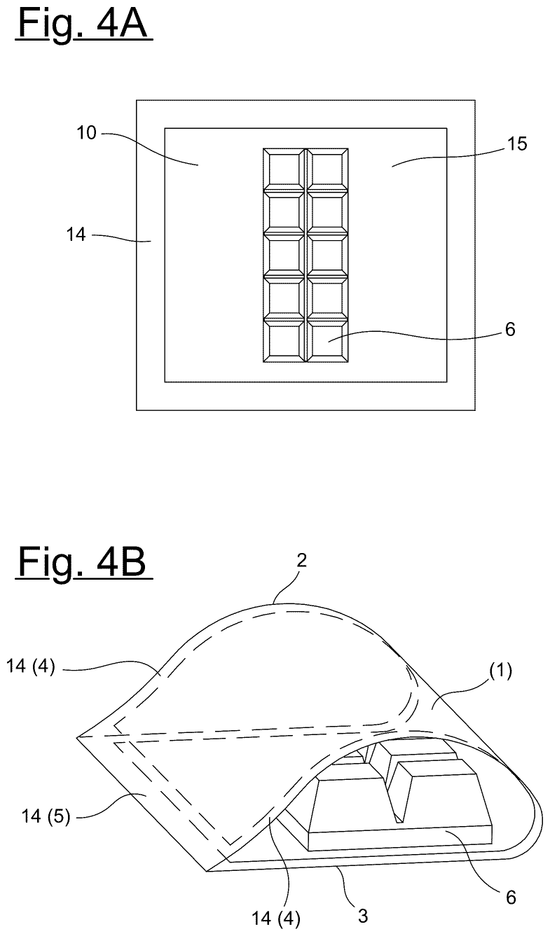

FIGS. 4A, 4B consecutive steps for the production of a packaging pouch according to FIG. 1.

FIG. 1 shows a packaging pouch according to the invention, having a pouch body 1 configured as a tubular pouch body.

This pouch body 1 has transverse sealing seams 4 at an upper and a lower end 2, 3, as well as a longitudinal sealing seam 5 that connects the ends 2, 3, by way of which seam the pouch body 1 is closed off.

The packaging pouch serves for packaging the packaged product 6, not shown in any detail in FIG. 1, wherein this packaged product 6 is primarily a food, in particular a food that contains fat. In this regard, the packaged product 6 can be configured, for example, as a chocolate bar or a granola bar.

Since the packaged product 6 is usually first placed onto the packaging web material provided for forming the pouch body 1, and the pouch body 1 is only then produced, by means of folding the packaging web material onto itself, in the form of a tube, such a packaging pouch is also referred to as a tubular pouch or tubular pouch packaging.

FIG. 2 then shows the structure of the packaging web material used for the pouch body 1, which material is essentially formed from a paper ply 7. This paper ply has a kraft paper ply 8, which has a coated surface 9 on a first side, formed by a pigment coating. By way of this coated surface 9, it is possible to create a comparatively sealed and smooth base for a barrier coating 10 arranged on top of it, which coating penetrates to a comparatively slight extent into the material of the paper ply 7, due to the coated surface 9, and thereby can be configured to be sealed, in a suitable manner, without using a large application amount for the barrier coating 10.

In contrast to this, the paper ply 7 is untreated on a second side, and thereby it is configured with an uncoated surface 11. Alternatively, it is also possible to provide the surface 11 of the second side with a pigment-free coating. In each case, however, no pigment coatings are used. On the surface 11 of the second side of the paper ply 7, a printed layer 12 is then arranged, at least in certain sections, for printing, and a separating layer 13 is arranged on the printed layer 12. By means of the untreated surface 11 of the second side of the paper ply 7, the printed layer 12 penetrates relatively deeply into the paper ply 7, and thereby the printed layer 12 has a relatively rough printed image that nevertheless still has sufficient quality. At the same time, the printed image and also the composition of the uncoated surface 11 have a particularly natural effect, so that the sustainability of the packaging web material being used is imparted to the consumer solely by means of the packaging. Since the printed layer 12 usually does not extend over the entire uncoated surface 11, the separating layer is arranged directly on the uncoated surface 11, at least in certain regions.

The paper ply 7 used for the packaging web material has a weight per area between 40 and 80 g/m², in particular between 50 and 80 g/m², and is provided with a barrier coating 10 that has an application weight between 2 and 10 g/m². As a result, the barrier coating 10 forms a resistance of less than 10 according to Tappi T559.

Furthermore, a sealing layer 14 is arranged on top of the barrier coating 10, by way of which layer the pouch body 1 can be formed by means of sealing. The sealing layer 14 is configured as a cold-sealing layer and brings about the result that the formation of the transverse sealing seams 4 and of the longitudinal sealing seam 5 is brought about solely by means of applying a contact pressure. Fundamentally, the barrier coating 10 already has a certain sealability. However, in this regard it is merely possible to carry out sealing in the form of heat-sealing. In this regard, not only is a press-down pressure applied, but heat is also supplied externally, which two effects bring about at least partial melting of the barrier coating 10. Since heat-sealing is often not desired in the case of specific packaged products 6, in particular in the case of foods, an additional sealing layer 14 in the form of a cold-sealing layer is applied.

In this regard, the particular feature is that the sealing layer 14 is not arranged on the barrier coating 10 over its full area, but rather only in those sections in which the transverse sealing seams 4 and the longitudinal sealing seam 5 are supposed to be formed subsequently.

With the separating layer 13, furthermore the result is also achieved that the packaging web material can first be rolled up, and, at the same time, removal without interlocking of the material to itself is possible. Such interlocking is then possible, in particular, in those regions in which a sealing layer 14 has been provided. By means of the embodiment as a cold-sealing layer, it is easily possible, accordingly, to bring about adhesion to section of the packaging web material by means of the pressure that occurs when rolling it up.

FIG. 3 shows a detail of a packaging web that is formed from the packaging web material according to FIG. 2, wherein a top view of the first side of the paper ply 7 is shown. Accordingly, the sealing layer 14 is arranged on the barrier coating 10 in a frame-shaped pattern.

Accordingly, regions 15 of the barrier coating 10 that are free of sealing seams remain, which regions are accordingly free of a sealing layer 14.

By means of cutting off a section of the packaging web material that is intended for the formation of a pouch body 1, a frame-shaped sealing layer 14 then forms according to FIG. 4A, which layer encloses the packaging web material and, at the same time, forms a region 15 on the barrier coating 10, which region is free of a sealing coating 14 and on which region the packaged product 6 is then arranged. Accordingly, the packaged product 6 does not come into contact with the sealing layer 14.

Then, according to FIG. 4B, the packaging web material is folded in such a manner that sealing seam sections of the sealing layer 14 lie on top of one another, wherein then transverse sealing seams 4 at an upper and a lower end 2, 3, and a longitudinal sealing seam 5 can be introduced, by means of which the pouch body 1 is closed off. The step of sealing is not shown in any detail in the figures, wherein, however, this sealing exclusively takes place in the regions in which a sealing layer 14 is provided. Furthermore, sealing takes place exclusively by means of applying a press-down force, for example by means of sealing jaws. These sealing jaws are neither heated, nor does the introduction of heat into the sealing layer 14 take place in any other way. Since sealing thereby takes place at room temperature, this is also referred to as cold-sealing.

1. A packaging web material composed of a paper ply (7), which has a barrier coating (10) on a first side, and printing (12) on an opposite, second side, and wherein the paper ply (7) has a coated surface (9) formed by a pigment coating on the first side,
wherein
the paper ply (7) has an uncoated surface (11) on the second side, or a coated surface formed by a pigment-free coating, to which surface the printing (12) is applied.

2. The packaging web material according to claim 1, wherein the barrier coating (10) has an application weight between 2 and 10 g/m².

3. The packaging web material according to claim 1, wherein the barrier coating (10) is formed by a barrier varnish.

4. The packaging web material according to claim 1, wherein the barrier coating (10) has a fat resistance of less than 10 according to Tappi T559.

5. The packaging web material according to claim 1, wherein the paper ply (7) is formed by a kraft paper (8).

6. The packaging web material according to claim 1, wherein the paper ply (7) has a weight per area between 40 and 80 g/m².

7. The packaging web material according to claim 1, wherein a sealing layer (14) is provided on the barrier coating (10), at least in certain sections.

8. The packaging web material according to claim 7, wherein the sealing layer (14) is arranged in a frame shape or in a frame-shaped pattern.

9. The packaging web material according to claim 7, wherein the sealing layer (14) is configured as a cold-sealing layer.

10. The packaging web material according to claim 1, wherein a separating layer (13) is provided on the second side of the paper ply (7), on which side printing (12) is provided.

11. The packaging web material according to claim 1, wherein the paper ply (7) forms more than 90% of the total weight.

12. A packaging pouch having a pouch body (1) formed from the packaging web material according to claim 1, wherein the first side of the paper ply (7), which side has the barrier coating (10), forms the interior.

13. The packaging pouch according to claim 12, wherein the pouch body (1) is configured as a tubular pouch body and is closed off, at an upper end and a lower end (2, 3), by way of transverse sealing seams as well as along a longitudinal sealing seam (5) that connects the upper and lower ends (2, 3).

14. The packaging pouch according to claim 13, wherein a packaged product (6) is arranged within the pouch body (1), in regions (15) of the packaging web material that are free of sealing seams.

15. A method for forming a packaging pouch, wherein the packaging web material according to claim 1 is folded in such a manner that the first side of the paper ply (7), which side has the barrier coating (10), forms an interior, and the opposite second side of the paper ply (7) forms an outside.

16. The method according to claim 15, wherein sealing layer sections of the sealing layer (14) that are arranged on the barrier coating (10) are laid on top of one another during folding, in such a manner that sealing layer sections that extend in a transverse direction are formed at an upper end and a lower end, and a sealing layer section that connects the ends in the longitudinal direction is formed, and wherein subsequently the pouch body (1) is closed off by means of sealing the sealing layer sections.

17. The method according to claim 16, wherein a packaged product (6) is arranged on the first side before folding the packaging web material, in such a manner that the product does not lie against sealing layer sections after folding.
